(19) United States
(12) Patent Application Publication
(10) Pub. No.: US 2006/0155520 A1
(43) Pub. Date: Jul. 13, 2006

(54) Model-based pre-assembly testing of multi-component production devices

(76) Inventors: Peter M. O'Neill, Ft. Collins, CO (US); Ajay Khoche, San Jose, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/139,152

(22) Filed: May 27, 2005

Related U.S. Application Data
(60) Provisional application No. 60/643,315, filed on Jan. 11, 2005.

(51) Int. Cl. G06Q 99/00; G06G 7/48

(52) U.S. Cl. 703/11; 703/12; 705/1

(57) ABSTRACT

A multi-component production devices in accordance with a device design having performance specifications is made by a method comprising receiving respective component behavioral models of the production components constituting the production device; combining the component behavioral models in accordance with the device design to form a device behavioral model; and, prior to assembling the production device, and predicting performance metrics for the production device by performing simulated tests on the device behavioral model.

### CLAIM OF PRIORITY

This application claims priority under 35 USC §119(e) of pending U.S. provisional patent application No. 60/643,315 filed 11 Jan. 2005.

### BACKGROUND

As electronic devices, especially those sold in the consumer market, become more complex and physically smaller, the circuitry therein is becoming increasingly integrated. Devices known as Systems-in-Packages (SiPs) and also known as Multi-Chip Modules (MCMs) and Multi-Chip Packages (MCPs) are increasing being used in such products to provide greater circuit complexity in a package of smaller size.

SiPs are composed of interconnected components such as bare integrated circuit dice and discrete passive components encapsulated in a common package. The components are typically supported and interconnected by a substrate that can be regarded as another component of the SiP.

SiPs, especially those used in consumer products, are uneconomical to repair for reasons that include the following. The encapsulation is common to all the components. To expose a faulty component, the entire device must be de-encapsulated. The de-encapsulation process can damage the components of the SiP. Additionally, the connections between the components of the SiP cannot be undone without causing damage. For example, breaking a wire bond will leave the bond foot on the bonding pad or will lift the bonding pad metal. In another example, the underfill adhesive cannot readily be removed from face of a flip-chip. Connections need to be undone to remove a faulty component. Additionally, it is typically expensive to identify the faulty component in such devices.

Accordingly, what is needed to reduce the cost of manufacturing SiPs and other devices in which repairs are difficult, expensive, or otherwise undesirable, is to maximize the yield of newly-assembled production devices whose performance metrics meet the performance specifications of the device design. Ensuring that the performance metrics of the production devices in their “as manufactured” state meet the performance specifications of the device design reduces the number of production devices that have to be discarded or expensively and riskily repaired and, hence, the overall cost of manufacturing each production device.

One common reason why the performance metrics of a newly-assembled production device, and a SiP in particular, will not meet the performance specifications of the device design is that the performance specifications of the component designs constituting the device design are typically too broad to guarantee an acceptably-high yield of devices whose performance metrics comply with the performance specifications of the device design.

Component tolerances are cumulative. For example, consider a production device composed of a series combination of two production components A and B each characterized by a parameter P such that the production device has a performance metric P_{device} equal to P_{A}+P_{B}. In this example, a tolerance (T) is allowed on parameter P of ±T at tests performed on the production components and on the production device. Because A and B are independent, P_{A} and P_{B} are independent. In one possible combination of production components A and B, the tolerance of parameter P_{A} is +T and the tolerance of parameter P_{B} is −T. In this example, the tolerances cancel so that the production device has a nominal performance metric. In another combination of production components A and B, the tolerance of both production components is −T or +T. In this case, the performance metric P_{device} of the production device deviates from its nominal value by −2T or +2T, both of which are outside the allowed tolerance of ±T.

Tightening the performance specifications of the components will increase the yield of production devices but increases the cost of each device due to the increased cost of the components. Moreover, this approach results in many components being discarded that could form part of devices that comply with the performance specifications of the device design if they were combined with appropriate other components.

Another approach is to perform a component matching process before the components are assembled. The component matching process performs conventional parametric testing on batches of components and selects sets of components that are predicted to work together to produce acceptable in-specification production devices. However, this approach is only as good as the ability of the parametric tests performed on the components to predict the performance metrics of the production device made from the components. Thus, this approach typically does not eliminate the need to perform comprehensive final testing of each assembled production device. Moreover, as the components have become more complex, the cost of testing them and the processing needed to select the matched sets of components have both increased sharply. This is especially problematic with components having analog behaviors in which the tolerances do not always combine linearly.

What is needed, then, is a simpler, lower-cost way to increase the yield and eliminate the wastage costs of production devices composed of multiple components. What is also needed is a simpler way of manufacturing such devices by eliminating the need to perform comprehensive final testing on each production device.

### SUMMARY OF THE INVENTION

In a first aspect, the invention provides a method of making a multi-component production device in accordance with a device design. The method comprises receiving respective component behavioral models of the production components constituting the production device; combining the component behavioral models in accordance with the device design to form a device behavioral model; and, prior to assembling the production device, predicting performance metrics for the production device by performing simulated tests on the device behavioral model.

In an embodiment, the method additionally comprises checking compliance of the predicted performance metrics of the production device with the performance specifications of the device design, and, when the checking indicates that the performance metrics comply with the performance specifications, assembling the components to form the production device.

In another embodiment, batches of component behavioral models are received corresponding to batches of the production components; sets of the component behavioral models are made from the batches of component behavioral models and the component behavioral models in each set of the component behavioral models are combined to form the device behavioral model of a respective possible production device. Then, performance metrics are predicted for each possible production device by performing simulated tests on the device behavioral model of the possible production device and the production components whose component behavioral models constitute the respective device behavioral models of the possible production devices that meet a specified manufacturing objective are selected for assembly.

In another aspect, the invention provides a method of making a production device in accordance with a device design. The production device comprises production components each in accordance with a respective component design. The method comprises receiving a component model form for each of the component designs, the component model form comprising a basis function and model form parameters; combining the component model forms in accordance with the device design to form a device model form; receiving values of the model form parameters for the production components; inserting the values of the model form parameters into the component model forms constituting the device model form to form a device behavioral model of the production device; and, prior to assembling the production device, predicting performance metrics for the production device by performing simulated tests on the device behavioral model.

Embodiments of the method increase the productivity of production line test equipment by eliminating the need to perform post-assembly parametric testing. Embodiments of the method additionally reduce waste by allowing only sets of components known to produce a production device whose performance metrics comply with the performance specifications of the device design to be assembled. Embodiments of the invention can also select for assembly sets of production components whose component behavioral models constitute the device behavioral models of possible production devices that meet a specified manufacturing objective. Examples of manufacturing objectives include maximizing the number of production devices whose performance metrics comply with the performance specifications, maximizing the performance metrics of the production devices, approximating the production of production devices having a common device design but different performance specifications to market demand and any other manufacturing objective that may be optimized using performance metrics predicted using the device behavioral model of a possible production device.

### BRIEF DESCRIPTION OF THE DRAWINGS

FIG. 1 is a flow diagram of an example of a first embodiment of a method in accordance with the invention of making a multi-component device.

FIG. 2 is a flow diagram of an example of a second embodiment of a method in accordance with the invention of making a multi-component device.

FIG. 3 is a flow diagram of an example of a third embodiment of a method in accordance with the invention of making a multi-component device.

FIG. 4 is a flow chart of a fourth embodiment of a method in accordance with the invention of making a multi-component device.

FIG. 5 is a flow chart showing an example of a fifth embodiment of a method in accordance with the invention of making multi-component production devices.

FIG. 6 is a flow diagram showing an example of how component usage is maximized in the embodiment shown in FIG. 5.

FIG. 7 is a flow diagram showing an example of how the production of production devices with two levels of performance is approximated to market demand in the embodiment shown in FIG. 5.

FIG. 8 is a flow diagram showing an example of how the production of production devices with two or more levels of performance is approximated to market demand in the embodiment shown in FIG. 5.

FIG. 9 is a flow diagram showing an example of a process that can be used to generate the component behavioral models.

FIG. 10A is a flow diagram showing an example of a model form development process that can be used to develop the component model form on which the component behavioral models of the production components are based.

FIG. 10B is a flow diagram showing an example of the model form generation block of the process shown in FIG. 10A.

FIG. 10C is a flow diagram showing an example of the model form validation block of the process shown in FIG. 10A.

FIG. 11 is a flow diagram showing an example of a process for specifying a stimulus used in generating the component behavioral models.

### DETAILED DESCRIPTION

As used in this disclosure, the term component will be used to denote an electronic module having more than one element. A component design defines the structure of a component, relevant parameters of a component manufacturing process used to manufacture multiple instances of the component, i.e., production components, and the performance specifications met by the production components. The performance of a component design is specified by performance specifications of the component design. Conventionally, after manufacture, each component made in accordance with the component design is subject to parametric testing to determine whether its performance metrics comply with the corresponding performance specifications of the component design. A component whose performance metrics all comply with the corresponding performance specifications is classified as good by the production testing and is released for sale.

In accordance with the invention, in addition to or instead of conventional parametric testing, each production component is subject to testing that provides test results from which a component behavioral model of the individual production component is derived. The component behavioral model for each production component is supplied to the device manufacturer in addition to the production component itself, although the component behavioral model and the respective production component need not be supplied to the same entity. In component designs that incorporate suitable memory, the component behavioral model for the production component may be stored in the production component's own memory. Otherwise, the production components are individualized in a manner that allows the production component corresponding to each component behavioral model to be clearly identified. In an example, an external surface of each production component is marked with a bar code that represents a serial number and the component behavioral model of the production component stored is in a computer-readable medium and is identified by the same serial number. The behavioral models of production components supplied in temporary carriers conventionally used in the industry and known as waffle packs are supplied linked to the positions of the respective production components in the waffle pack.

As used in this disclosure, the term device will be used to denote an electronic module composed of more than one component. A device design defines the structure of the device, relevant parameters of a device manufacturing process used to manufacture multiple instances of the device, i.e., production devices, and the performance specifications met by the production devices.

A device may be an electronic product in the form in which such product is sold to an end-user. Alternatively, a device may be an electronic product that constitutes part of an electronic product in the form in which such product is sold to an end user. Examples of devices that constitute part of an electronic product are multi-chip modules (MCMs) and systems in packages (SiPs). Methods in accordance with the invention are applicable to the manufacture of devices regardless of whether the manufactured devices are sold directly to an end-user or constitute part of another, more complex device. In the case of devices that form part of another, more complex device, during application of an embodiment of the method in accordance with the invention to the manufacture of such devices, the devices are regarded as production devices. Then, during application of an embodiment of the method in accordance with the invention to the manufacture of the more complex production devices each incorporating one or more of the devices, the devices are regarded as production components of the more complex production devices.

Conventionally, after manufacture, each production device is subject to parametric testing to determine whether the performance metrics of the production device comply with the corresponding performance specifications of the device design. A production device whose performance metrics all comply with the corresponding performance specifications is classified as GOOD by the production testing and is released for sale. As noted above, such parametric testing is expensive, and testing production devices only after they have been assembled leads to wastage.

Embodiments of the invention are based on two discrete concepts. The first concept is that, for a given component design, a component model form having no more than a few tens of model form parameters can be developed. Such a component model form is sensitive to process parameter variations and is capable of modeling the component design to a specified accuracy with respect to the performance specifications of the component design. Even complex component designs, including such non-linear component designs as transmitters and transceivers, can be modeled using a component model form having fewer than 100 model form parameters to an accuracy sufficient for predicting the performance metrics of production devices incorporating production components in accordance with the component design. The component model form mathematically models the behavior of the component design with respect to the performance specifications of the component design. Component behavioral models based on the component model form will mathematically model the behavior of production components fabricated in accordance with the component design.

In an embodiment, component behavioral models of production components in accordance with a component design are based on a component model form comprising a basis function of non-linear equations and model form parameters for the basis function. The basis function and the model form parameters are the same for all production components made in accordance with the component design. The model form parameters differ in value among the production components.

The second concept is that a single test can be performed on each production component, values of the model form parameters can be extracted from the results of the single test using the component model form, and the values of the extracted component model form parameters can be inserted into the basis function to produce a component behavioral model. The component behavioral model models the production component with an accuracy sufficient to allow the component behavioral models of the production components constituting a production device to be combined to form a device behavioral model of the production device. The device behavioral model models the behavior of the production device with sufficient accuracy that simulated tests performed on the device behavioral model will produce predicted performance metrics that allow compliance of the production device with the performance specifications of the device design to be reliably predicted before the production components are assembled to form the production device itself.

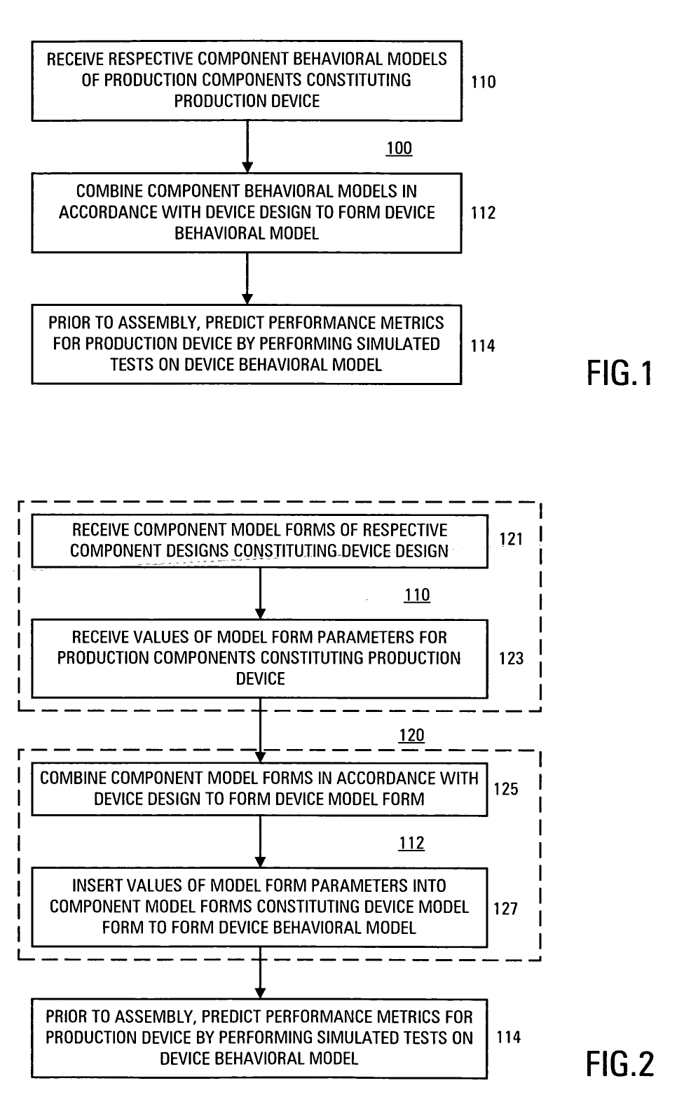

FIG. 1 is a flow chart of an example of a first embodiment 100 of a method in accordance with the invention for making a multi-component production device in accordance with a device design. In accordance with the method, in block 110, respective component behavioral models of the production components constituting the production device are received. In block 112, the component behavioral models are combined in accordance with the device design to form a device behavioral model. In block 114, performance metrics for the production device are predicted prior to assembling the production device by performing simulated tests on the device behavioral model.

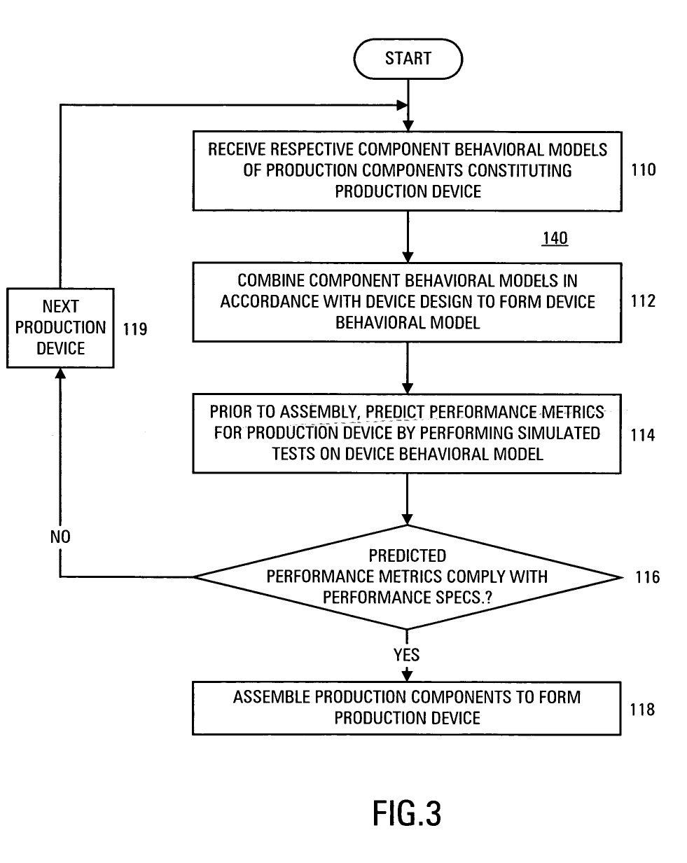

FIG. 2 is a flow chart of an example of a second embodiment 120 of a method in accordance with the invention for making a multi-component production device. Second embodiment 120 is based on first embodiment 100 and corresponding elements are indicated by the same reference numerals. Method 120 is for use when the component model form of each component design constituting the device design is composed of a basis function and model form parameters for the basis function. The individual production components constituting the production device are subject to testing and values of the model form parameters are extracted from the test results.

In the example shown in FIG. 2, an embodiment of block 110 comprises block 121 and block 123, and an embodiment of block 112 comprises block 125 and block 127. In block 121, the component model forms of the respective component designs constituting the device design are received. In block 123, values of the model form parameters of the production components constituting the production device are received.

In block 125, the component model forms are combined in accordance with the device design to form the device model form. In block 127, the values of the model form parameters are inserted into the component model forms constituting the device model form to form the device behavioral model. Specifically, the values of the model form parameters are inserted into the basis functions constituting the respective component model forms.

Block 114 is then performed on the device behavioral model as described above with reference to FIG. 1.

Method 120 saves computational resources compared with method 100 when used to make more than one production device in accordance with the same device design because block 125 need only be performed once for a given device design unless one or more of the component model forms change. Blocks 110 and 112 may be structured as described with reference to FIG. 2 in any of the embodiments described below.

In an exemplary practical implementation of method 120, the component behavioral models are combined in accordance with the device design to form the device behavioral model using a behavioral simulator such as that sold under the trademark Simulink® by The MathWorks, Inc, Natick, Mass., or the Advanced Design System sold by Agilent Technologies, Inc, Palo Alto, Calif. The device behavioral model and its target simulator are then installed on a computer with access to the values of the model form parameters for the production components.

The device behavioral model of the production device generated in block 112 allows the performance metrics of the production device to be predicted with accuracy comparable with that of performance metrics measured on the assembled production device by conventional post-assembly parametric testing. This accuracy allows the predicted performance metrics to be used in several ways. In one example, the predicted performance metrics are simply used instead of conventional parametric testing to determine whether the production device complies with the performance specifications of the device design. Eliminating post-assembly parametric testing increases the productivity of production line test equipment and reduces the cost of testing the production devices.

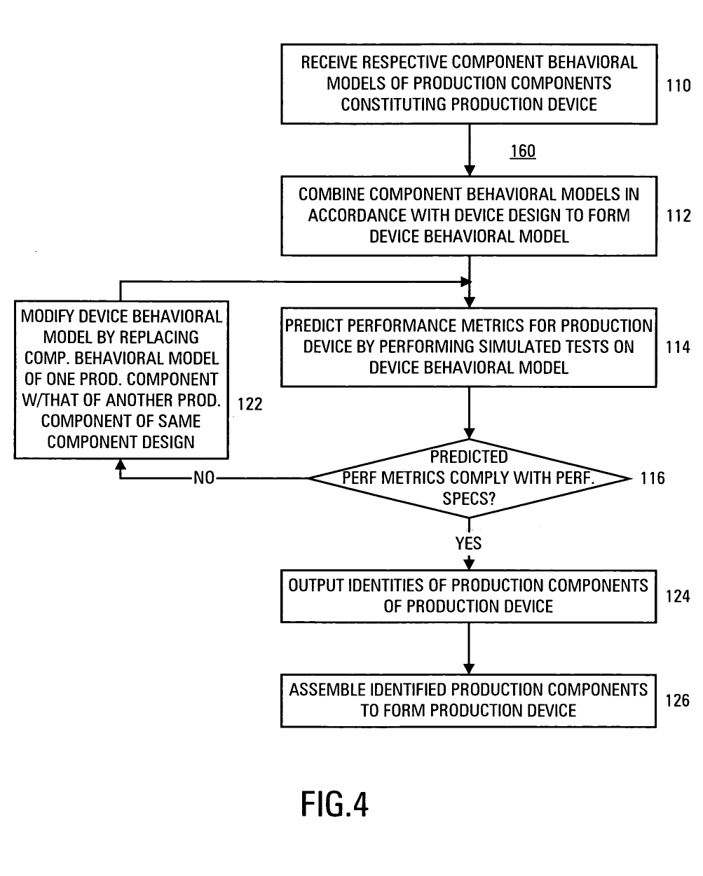

FIG. 3 is a flow chart of an example of a third embodiment 140 of a method in accordance with the invention for making a multi-component production device in which the pre-assembly prediction of the performance metrics of the production device is used instead of post-assembly parametric testing to determine whether the production device complies with the performance specifications of the device design. Third embodiment 140 is based on first embodiment 100 and corresponding elements are indicated by the same reference numerals.

Blocks 110, 112 and 114 are performed as described above. In block 116, compliance of the predicted performance metrics of the production device with the performance specifications of the device design is checked. When the result obtained in block 116 is YES, i.e., the predicted performance metrics of the production device comply with the performance specifications of the device design, block 118 is performed. In block 118, the production components are assembled to form the production device. When the result obtained in block 116 is NO, the production components are not assembled, and execution advances to block 119, where the next production device is selected. The process just described is then repeated on the next production device.

A simple functional test may be performed on the assembled production device to ensure that a working device has been produced. Alternatively, operation of the production device can be verified by a simple test of its component interconnections such as one performed using IEEE standard 1149 series of boundary scan techniques. Replacing a comprehensive set of parametric tests with a simple functional or component interconnection test increases the productivity of production line test equipment and reduces the cost of testing the production devices.

In another embodiment, the predicted performance metrics are used to reduce waste by changing the component behavioral models that constitute the device behavioral model until predicted performance metrics that meet the performance specifications of the device design are obtained. The production components corresponding to the component behavioral models that finally constitute the device behavioral model are the assembled to form a production device.

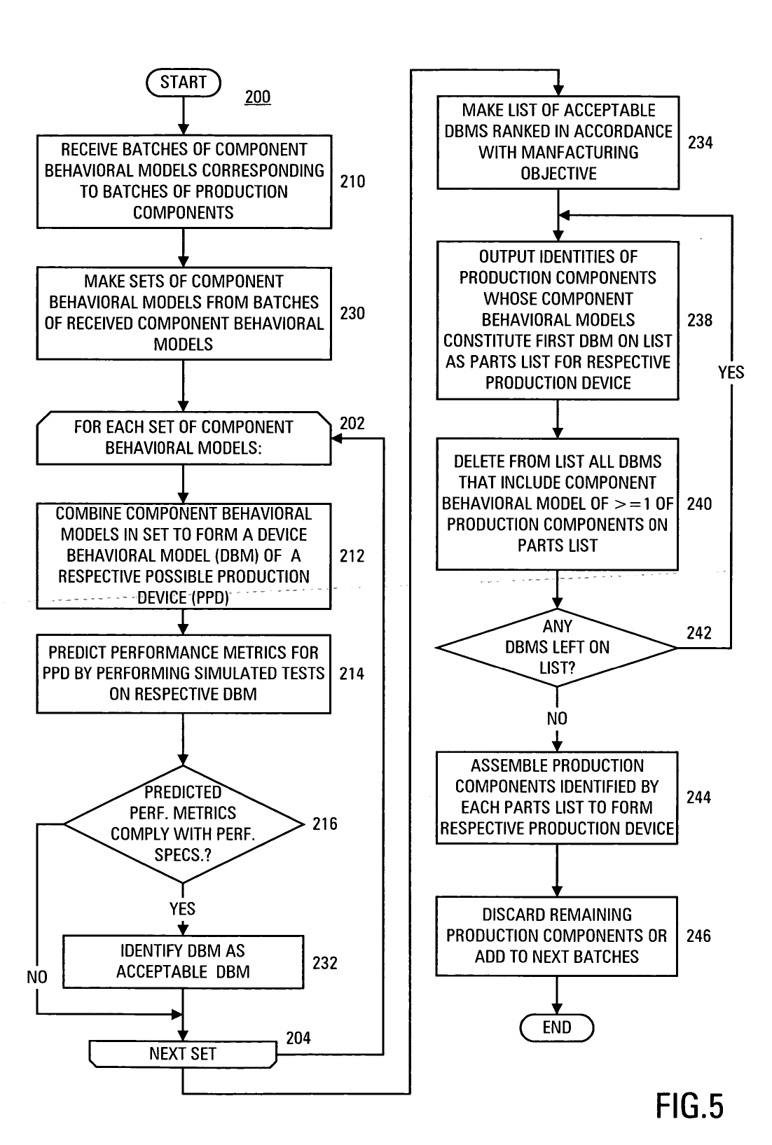

FIG. 4 is a flow chart of a fourth embodiment 160 of a method in accordance with the invention of making a multi-component device in accordance with a device design. Blocks 110, 112, 114 described above with reference to FIG. 1 are performed. Block 116 is then performed. In block 116, compliance of the predicted performance metrics generated in block 114 with the performance specifications of the device design is checked, as described above with reference to FIG. 3.

When the result in block 116 is NO, block 122 is performed. In block 122, the device behavioral model is modified by replacing the component behavioral model of one of the production components with the component behavioral model of another of the production components of the same component design. The modification process forms a modified device behavioral model. Then, block 114 is repeated using the modified device behavioral model and compliance of the performance metrics of the modified device behavioral model with the performance specifications is re-checked at block 116.

When the result obtained in block 116 is YES, and the performance metrics of the device behavioral model, i.e., the original device behavioral model or the modified device behavioral model, comply with the performance specifications of the device design, block 124 is performed. In block 124, the identities of the production components whose component behavioral models were combined to form the device behavioral model whose performance metrics met the performance specifications of the device design are output. The production components whose identities are output are those whose component behavioral models were combined to form the original behavioral model when block 116 is performed only once or those whose component behavioral models were combined to form the modified behavioral model when block 116 is performed more than once.

Block 126 is then performed. In block 126, the production components identified in block 124 are assembled to form a production device. Operation of the production device may be verified using simple functional with a simple functional or component interconnection test rather than conventional parametric tests, as described above.

The loop of which block 122 forms part may be repeated as many times as needed to obtain a YES result in block 116. The component behavioral model of a production component of a different component design may be replaced each time block 122 is performed. Alternatively, the component behavioral model of a production component of the same component design may be replaced each time.

Since only production components whose component behavioral models combine to form a device behavioral model whose predicted performance metrics comply with the performance specifications of the device design are assembled, assembly costs are reduced. Moreover, wastage is typically reduced because few, if any, production devices are rejected after assembly and have to be scrapped or are subject to rework. Additionally, the production components whose component behavioral models were replaced in the device behavioral model do not necessarily have to be scrapped since the component behavioral models of such production components may well form device behavioral models whose performance metrics comply with the performance specifications of the device design when combined with the component behavioral models of different production components.

Embodiments of method 160 typically increase the number of production devices that meet the performance specifications of the device design that can be assembled from a given number of received production components. However, the distribution of the performance metrics of the production device produced by embodiments of method 160 is similar to that produced by a conventional assembly and test process.

In block 124, the device behavioral model of the production device is modified simply by replacing the component behavioral model of one production component with the component behavioral model of another production component of the same component design in the device behavioral model. The replacement is typically accomplished by modifying a memory address in a computer. No production components are handled to accomplish the replacement. Specifically, the device behavioral model is modified in the computer on which the device behavioral model is running by replacing the address of a block of data representing the component behavioral model of one production component with the address of a block of data representing the component behavioral model of the replacement production component. The simulated tests are then performed on the modified device behavioral model simply by re-running the performance metric computations on the modified device behavioral model.

The component behavioral model removed when the device behavioral model is modified can be combined with the component behavioral models of other production components in the device behavioral model of another production device. In the event that the performance metrics of the other production device are predicted to comply with the performance specifications of the device design, the production components identified as constituting the other production device are assembled to form the other production device. The performance metrics of the other production device comply with the performance specifications of the device design even though the production device comprises a production component that was originally part of a production device whose performance metrics were predicted not to comply with the performance specifications. Thus, embodiments of the invention minimize the number of production devices that need physical rework and minimize the number of production components and production devices that have to be scrapped.

Production devices are typically manufactured in a continuous production process or in a batch production process. In either continuous or batch production, production components are typically supplied in batches. Embodiments of the method in accordance with the invention can be applied in the manufacture of production devices in which the production components are received in batches. Such embodiments allow not only compliance of production devices with the performance specifications of the device design to be predicted prior to assembling the production components but also the production process to be optimized to meet an additional manufacturing objective. Examples of manufacturing objectives include maximizing the number of production devices whose performance metrics comply with the performance specifications, maximizing the performance metrics of the production devices, approximating the production of production devices having a common device design but different performance specifications to market demand and any other manufacturing objective that can be optimized using performance metrics predicted using the device behavioral model of a possible production device.

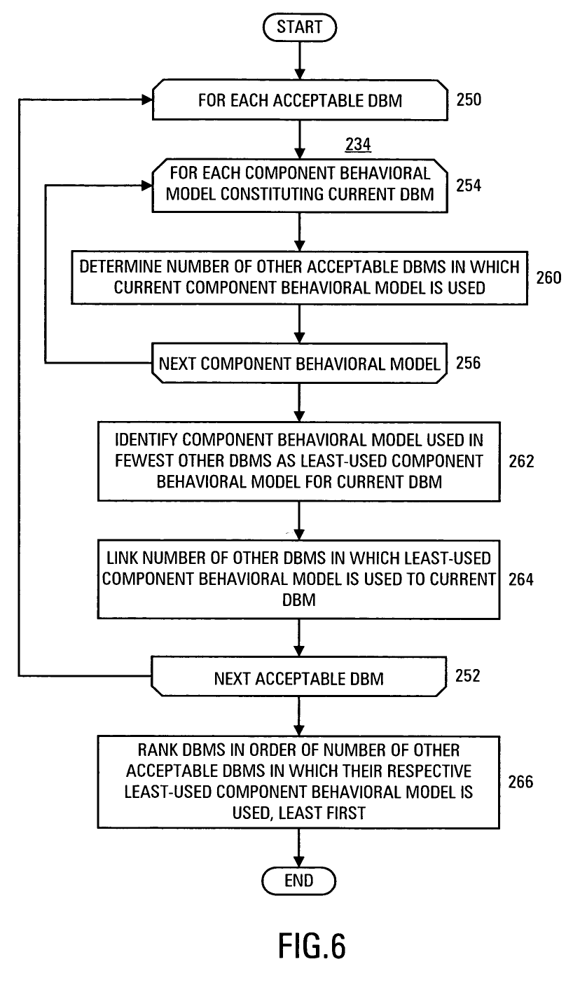

FIG. 5 is a flow chart showing an example of a fifth embodiment 200 of a method in accordance with the invention for making multi-component production devices.

In block 210, batches of component behavioral models are received. The batches of the component behavioral models correspond to batches of the production components that will be assembled to form the production devices. In block 230, sets of the component behavioral models are made from the received batches of component behavioral models. Each set of the component behavioral models will be used in block 212 (described below) to form the device behavioral model of a possible production device. In one embodiment, the sets of the component behavioral models collectively comprise every possible combination of the received component behavioral models. When the batches of production components are large or the device design comprises more than a few component designs, this approach generates very large numbers of sets of component behavioral models. In another embodiment, an approach similar to conventional production is taken and each component behavioral model is assigned to a single set of component behavioral models. This approach produces sets of component behavioral models equal in number to the number of component behavioral models in the smallest batch of component behavioral models.

Blocks 202 and 204 establish a for-next loop that is performed for each of the sets of component behavioral models identified in block 230. The for-next loop comprises blocks 212, 214, 216 and 232.

In block 212, the component behavioral models in the set are combined in accordance with the device design to form the device behavioral model of a respective possible production device. In block 214, performance metrics for the possible production device are predicted by performing simulated tests on the respective device behavioral model. In block 216, compliance of the predicted performance metrics of the possible production device with the performance specifications of the device design is checked.

When a YES result is obtained in block 216, i.e., the predicted performance metrics of the possible production device comply with the performance specifications of the device design, execution advances to block 232. In block 232, the device behavioral model of the possible production device is identified as an acceptable device behavioral model. Execution then advances to block 204.

When a NO result is obtained in block 216, execution advances directly to block 204.

The for-next loop bounded by blocks 202 and 204 is repeated until all the sets of component behavioral models have been processed. Execution then advanced to block 234.

In block 234, a list is made of the acceptable device behavioral models. Acceptable device behavioral models are the device behavioral models identified in block 232 as acceptable. In the list, the acceptable device behavioral models are ranked in accordance with the manufacturing objective.

In block 238, the identities of the production components whose component behavioral models constitute the first device behavioral model on the list are output as a parts list for a respective production device.

In block 240, all the acceptable device behavioral models that include the component behavioral model of at least one the production components in the parts list generated in block 238 are deleted from the list of acceptable device behavioral models. Such device behavioral models are deleted from the list because the component behavioral models of the production components in the parts list generated in block 238 are no longer available to constitute these device behavioral models.

In block 242, a test is performed to determine whether any acceptable device behavioral models remain on the list. When the test result is YES, execution returns to block 238, where the identities of the production components in the component set whose component behavioral models constitute the acceptable device behavioral model newly-located at the top of the list as a result of block 240 being performed are output as a parts list, as described above. Otherwise, execution advances to block 244.

In block 244, the production components identified by each of the parts lists generated in block 238 are assembled to form a respective production device. Optionally, a simple functional test may be performed on each assembled production device to ensure that a working device has been produced, but typically no parametric testing is needed, as described above.

In block 246, production components remaining after the production devices have been assembled in block 244 are discarded or are added to batches of production components on which the method 200 will be performed in future.

In an alternative embodiment, no parts list is generated in block 238. Instead, the production components whose component behavioral models constitute the first device behavioral model on the list in block 238 are assembled (not shown) to form a respective production device. In this embodiment, block 244 is not performed. In another embodiment, the parts list output in block 234 comprises the identities of the component behavioral models constituting the first device behavioral model and the production components to be assembled in block 244 are identified from the identities of the corresponding component behavioral models. In a further embodiment, the identity of the first device behavioral model on the list is output in block 234 and the production components to be assembled in block 244 are identified from the identities of the component behavioral models constituting the identified device behavioral model.

In an embodiment of method 200, block 210 is similar in structure to the embodiment of block 110 described above with reference to FIG. 2 and block 212 is similar in structure to the embodiment of block 112 described above with reference to FIG. 2.

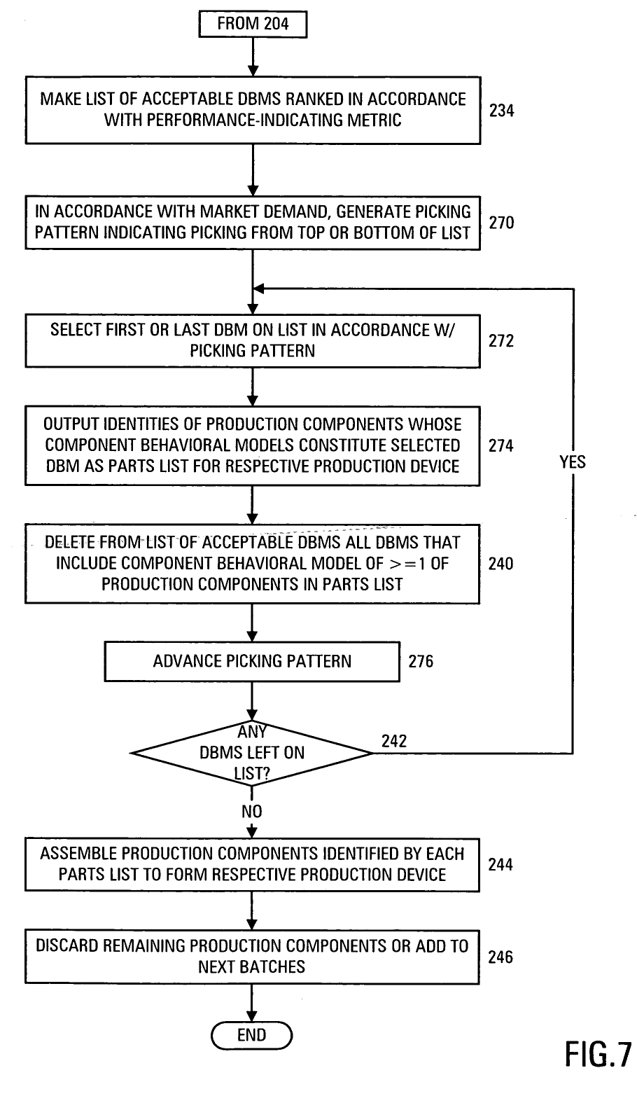

One possible manufacturing objective in accordance with which the acceptable device behavioral models are ranked in block 234 is maximizing the number of production devices that meet the performance specifications of the device design that can be manufactured from the batches of production components whose component behavioral models are received in block 210. FIG. 6 shows an exemplary embodiment of block 234 in an embodiment of method 200 in which the manufacturing objective is yield maximization.

In the example of block 234 shown in FIG. 6, blocks 250 and 252 establish a for-next loop that is performed for each acceptable device behavioral model identified in block 232. The device behavioral model for which the for-next loop bounded by blocks 250 and 252 is currently being performed will be referred to as the current device behavioral model. Blocks 254 and 256 establish a for-next loop that is performed for each component behavioral model constituting the current device behavioral model. The component behavioral model for which the for-next loop bounded by blocks 254 and 256 is currently being performed will be referred to as the current component behavioral model.

In block 260, the number of other acceptable device behavioral models in which the current component behavioral model is used is determined.

In block 262, the numbers of other acceptable device behavioral models obtained in block 260 for all the component behavioral models constituting the current device behavioral model are examined to identify which of the component behavioral models is the least-used component behavioral model, i.e., the component behavioral model used in the fewest other acceptable device behavioral models.

In block 264, the number of other acceptable device behavioral models in which the least-used component behavioral model of the current device behavioral model is used is linked to the current device behavioral model.

In block 266, the device behavioral models are ranked in the order of the number of other acceptable device behavioral models in which their respective least-used component behavioral model is used. The device behavioral model whose least-used component behavioral model is used in the fewest other acceptable device behavioral models is ranked first.

Accordingly, in block 238 of the embodiment of method 200 shown in FIG. 5, the production components whose identities are output are those that cause the fewest device behavioral models to be removed from the list in block 240. This maximizes the possibility that production components will be identified for assembly before all the device behavioral models are removed from the list.

In another embodiment of method 200, the manufacturing objective in accordance with which the acceptable device behavioral models are ranked in block 234 is maximizing the performance of the production devices produced from the production components whose component behavioral models are received in block 210. Prior to performing method 200, one of the performance metrics to be predicted in block 214 is selected as an indicator of the predicted performance of the device behavioral models, i.e., as a performance-indicating metric. Then, in block 234, the device behavioral models are ranked in the list in order of their performance-indicating metric, with the performance-indicating metric indicating highest performance first.

Instead of a single performance metric being used as the performance-indicating metric, two or more of the performance metrics predicted in block 214 may be combined, possibly with some form of weighting, to provide the performance-indicating metric. As a further possibility, one performance metric is identified as a primary performance-indicating metric and another performance metric is identified as a secondary performance-indicating metric. In this case, the device behavioral models are ranked in block 234 in order of their primary performance-indicating metric, and device behavioral models having the same primary performance-indicating metric are ranked in order of their secondary performance-indicating metric.

Some production devices of a given device design are sold with different performance specifications with production devices having higher performance specifications being sold at a higher price than production devices of the same device design having lower performance specifications. Sometimes, the distribution of the performance metrics of the production devices does not match the distribution of market demand. In an example in which the yield of production devices with performance metrics that meet the higher performance specification (higher-performance devices) is less than the demand for such devices, whereas the yield of production devices with performance metrics that meet the lower performance specifications (lower-performance devices) is greater than the demand for such devices, the financial return from selling the production devices will be less than optimum. Moreover, the manufacturer's inability to meet the customer's demand for the higher-performance devices may cause customer dissatisfaction. Increasing production to meet the demand for higher-performance devices deals with the customer dissatisfaction problem, but faces the manufacturer with the problem of disposing of the unsold lower-performance production devices.

In another example in which the yield of higher-performance devices is greater than the demand for such devices, the financial return from selling production devices will also be less than optimum since the excess higher-performance devices are typically supplied to meet the demand for the lower-performance devices. The manufacturer forgoes the additional revenue that would be obtained from selling the higher-performance devices as such. The financial return can be further reduced when customers discover that there is a reasonable probability that the manufacturer will supply higher-performance devices in response to an order for lower-performance devices. Such customers tend not to order- higher-performance devices.

The economic return from selling production devices sold with different performance specifications is typically optimized when the yields of higher- and lower-performance devices match the market demand for higher- and lower-performance devices, respectively.

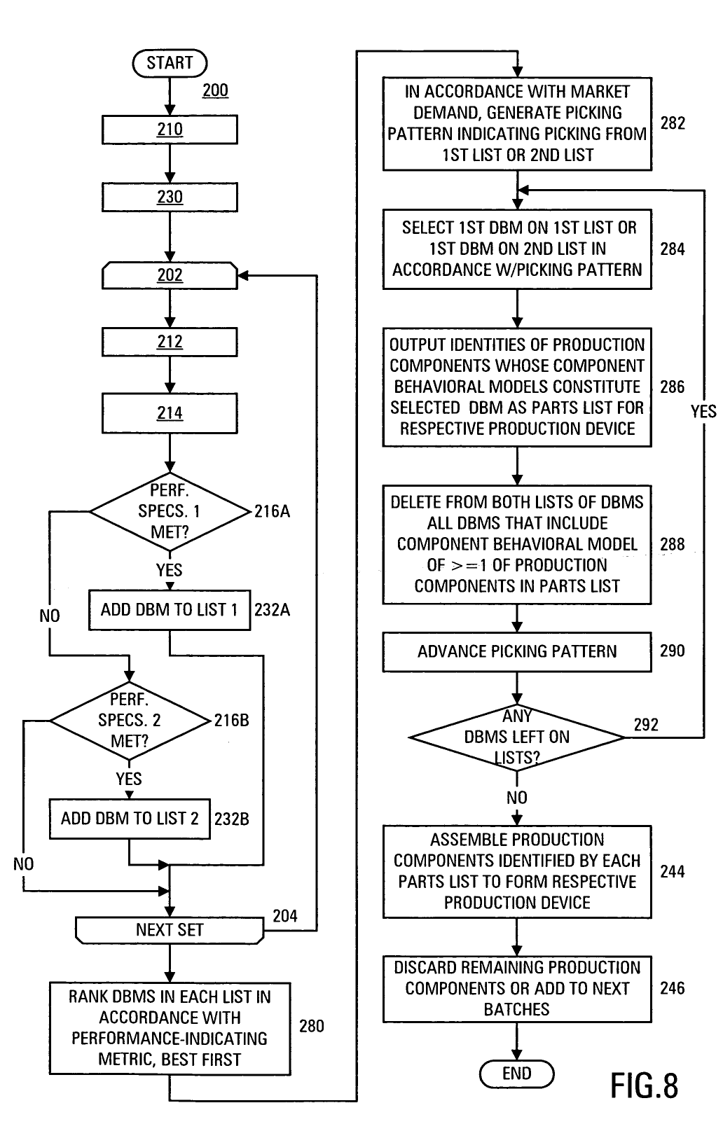

In another embodiment of method 200, the manufacturing objective is to approximate the production of higher-performance devices and lower-performance devices manufactured in accordance with a common device design to market demand. FIG. 7 shows a portion of an exemplary embodiment of method 200 in which the yields of higher-performance devices and lower-performance devices manufactured in accordance with a common device design are approximated to market demand. The portion shown begins at block 234. The portion of the embodiment prior to block 234 is as shown in FIG. 5.

In block 234, a list is made of the acceptable device behavioral models in which the acceptable device behavioral models are ranked in accordance with the above-described performance-indicating metric. The acceptable device behavioral model with the highest performance-indicating metric is ranked first.

In block 270, a picking pattern is generated in accordance with the market demand for the higher-performance devices and the lower-performance devices. The picking pattern is composed of a series of indicia. The maximum number of indicia is one indicium per acceptable device behavioral model. However, when the picking pattern is repetitive, as is typical, the number of indicia is equal to the non-repeated sequence. For example, in an embodiment in which the market demand is stated in increments of 5%, the picking pattern need have no more than 20 indicia. In this example in which the production devices are sold as higher-performance devices or lower-performance devices, the picking pattern is a series of two-state indicia, such as 1s and 0s. Each indicium indicates whether the first device behavioral model or the last device behavioral model is to be selected in block 272 from the list made in block 234. The fraction of the indicia in the state corresponding to picking the first device behavioral model on the list is proportional to the fraction of the market demand for the higher-performance devices, and the fraction of the indicia in the state corresponding to picking the last device behavioral model on the list is proportional to the fraction of the market demand for the lower-performance devices. For example, when the higher-performance devices account for 30% of the market demand for production devices and the lower-performance devices account for 70% of the market demand for production devices, the indicia in the state corresponding to picking the first device behavioral model on the list account for three of every ten of the indicia in the picking pattern and the indicia in the state corresponding to picking the last device behavioral model on the list account for seven of every ten of the indicia in the picking pattern. The indicia are arranged in the picking pattern in such a manner that they approximate their overall average over as short a sequence of the picking pattern as possible.

In block 272, the first device behavioral model or the last device behavioral model on the list is selected in accordance with the picking pattern, i.e., the first device behavioral model on the list is selected when the current indicium of the picking pattern is in one of its states, whereas the last device behavioral model on the list is selected when the current indicium of the picking pattern is in the other of its states.

In block 274, the identities of the production components whose component behavioral models constitute the selected device behavioral model are output as a parts list for a respective production device.

Block 240 is performed as described above.

In block 276, the picking pattern is advanced by one indicium.

Blocks 242, 244 and 246 are performed as described above.

As a result of ranking the acceptable device behavioral model on the list in order of their performance-indicating metric, production devices assembled from production components corresponding to the component behavioral models constituting successive first device behavioral models on the list have higher performance than production devices assembled from the production components corresponding to the component behavioral models constituting successive last device behavioral models on the list. Moreover, production devices are assembled from the production components corresponding to the component behavioral models constituting the successive first device behavioral models and the successive last device behavioral models in the same ratio as the market demand for higher-performance devices and lower-performance devices. Accordingly, the method causes number of higher-performance devices and lower-performance devices produced to approximate the market demand for such devices. However, the closeness of the approximation depends on the performance of the production components whose component behavioral models are received: for example, the production of higher-performance devices may exceed market demand for such devices when the production components received are all high-performance production components.

Embodiments of method 200 may include two optional additional blocks (not shown) typically located between blocks 242 and 244. In the first additional block, the predicted performance metrics of the device behavioral models selected in block 272 are compared with the performance specifications of the higher-performance devices and those of the lower-performance devices. Production devices made from production components whose component behavioral models constituted the device behavioral models selected from the top of the list but whose predicted performance metrics do not comply with the performance specifications of the higher-performance devices have to be sold as lower-performance devices. The first additional block can additionally track the number of production devices made from production components whose component behavioral models constituted the device behavioral models selected from the bottom of the list, and were therefore classified as lower-performance devices but whose predicted performance metrics comply with the higher-performance specifications.

In the second optional block, the number of device behavioral models whose predicted performance metrics meet the higher performance specification devices and the number of device behavioral models whose predicted performance metrics meet the lower performance specification identified by the first additional block are compared with the market demand for such devices. In the event of a significant mismatch between potential production and market demand, the method described above with reference to FIG. 7 can be repeated with one or more batches of higher-performance or lower-performance batches of production components with the aim of generating device behavioral models whose predicted performance metrics approximate market demand more closely. Since nothing has been assembled, performing this substitution costs only computer processing time.

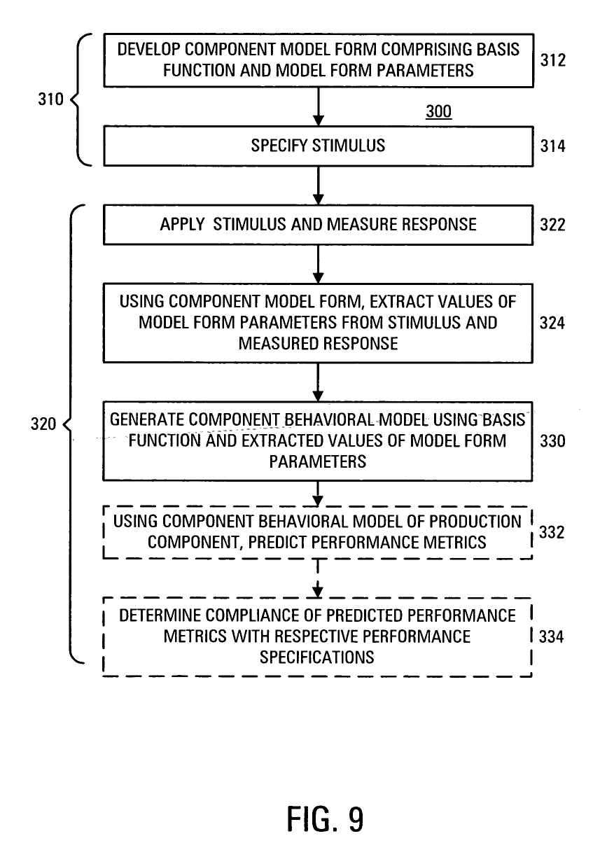

FIG. 8 shows another embodiment of method 200 in accordance with the invention in which the production of higher-performance devices and lower-performance devices in accordance with a common device design is approximated to market demand. In the embodiment shown in FIG. 8, blocks 210, 230, 202, 212 and 216 are performed as described above with reference to FIG. 5. In the example shown, the device design has two levels of performance specifications, i.e., higher-performance specifications met by the higher-performance devices and lower-performance specifications met by the lower-performance devices.

In block 216A, compliance of the predicted performance metrics of the possible production device with the higher-performance specifications of the device design is checked.

When a YES result is obtained in block 216A, i.e., the predicted performance metrics of the possible production device comply with the higher-performance specifications of the device design, execution advances to block 232A. In block 232A, the device behavioral model of the possible production device whose performance metrics were determined in block 216A to meet the higher-performance specifications of the device design is added to a first list that will be called List 1. Execution then advances to block 204.

When a NO result is obtained in block 216A, execution advances to block 216B.

In block 216B, compliance of the predicted performance metrics of the possible production device with the lower-performance specifications of the device design is checked.

When a YES result is obtained in block 216B, i.e., the predicted performance metrics of the possible production device comply with the lower-performance specifications of the device design, execution advances to block 232B. In block 232B, the device behavioral model of the possible production device whose performance metrics were determined in block 216B to meet the lower-performance specifications of the device design is added to a second list that will be called List 2. Execution then advances to block 204.

When a NO result is obtained in block 216B, execution advances directly to block 204.

The for-next loop bounded by blocks 202 and 204 is repeated until all the sets of component behavioral models identified in block 230 have been processed. Execution then advanced to block 280.

In block 280, the device behavioral models listed in List 1 are ranked in accordance with a performance-indicating metric, as described above. The device behavioral models listed in List 1 are those whose predicted performance metrics comply with the higher-performance specifications of the device design. Additionally, the device behavioral models listed in List 2 are ranked in accordance with the same performance-indicating metric, as described above. The device behavioral models listed in List 2 are those whose predicted performance metrics comply with the lower-performance specifications of the device design but do not comply with the higher-performance specifications of the device design. In List 1, the device behavioral model with the highest performance-indicating metric in List 1 is ranked first. In List 2, the device behavioral model with the highest performance-indicating metric in List 2 is ranked first.

In block 282, a picking pattern similar to that described above with reference to FIG. 7 is generated in accordance with market demand. In this embodiment, the states of the indicia constituting the picking pattern respectively indicate whether the first device behavioral model on List 1 is to be selected or if the first device behavioral model-on List 2 is to be selected.

In block 284, the first device behavioral model on List 1 or the first device behavioral model on List 2 is selected, depending on the state of the current indicium of the picking pattern.

In block 286, the identities of the production components whose component behavioral models constitute the device behavioral model selected in block 284 are output as a parts list for a respective production device.

In block 288, all the device behavioral models that include the component behavioral model of at least one the production components in the parts list generated in block 286 are deleted from List 1 and List 2. Such device behavioral models are deleted from both List 1 and List 2 because the component behavioral models of the production components whose identities are output in block 286 are no longer available to constitute these device behavioral models.

In block 290, the picking pattern is advanced by one indicium.

In block 292, a test is performed to determine whether any device behavioral models remain on List 1 or List 2. When the test result is YES, execution returns to block 284. In block 284, the device behavioral model newly-located at the top of List 1 or List 2 as a result of block 288 being performed is selected in accordance with the state of the current indicium of the picking pattern, as described above. Otherwise, execution advances to block 244.

Blocks 244 and 246 are performed as described above.

The embodiment of the method described above with reference to FIG. 8 is subject to limitations similar to those described above with reference to FIG. 7, i.e., the yield of high-performance devices will be low if the performance of the production components whose component behavioral models are received in block 210 is low. Additional blocks similar to those described above with reference to FIG. 7 can be added to monitor the quality of the approximation of production to market demand, as described above.

The embodiment shown in FIG. 8 can also be used to allocate production components between production devices having a common device design but with performance specifications that specify different aspects of performance in a manner that approximates market demand for such production devices. In an example, some of the production devices have a performance specification for high operational speed whereas the remaining production devices have a performance specification for low power consumption.

The embodiment of the method described above with reference to FIG. 8 can be expanded for use in connection with device designs that are sold with more than two levels of performance specifications or with performance specifications that specify more than two different aspects of performance. The method is expanded as follows. One or more pair of blocks similar to blocks 216A and 232A are added to the method in cascade with block 216B in a manner similar to the cascade arrangement between blocks 216B and 216A. Each additional pair of blocks similar to blocks 216A and 232A generates a respective list. The total number of lists is equal to the number of levels or aspects of performance specifications with which the device design is sold. The performance specifications against which the predicted performance metrics are checked in each additional block similar to block 216A are progressively lower.

In block 280, the device behavioral models in each list are ranked in accordance with the performance-indicating metric in a manner similar to that described above.

In block 282, the picking pattern is generated with each indicium having a number of states equal to the number of lists collectively generated in blocks 232A, 232B, etc. For example, in an embodiment in which four lists are generated, each indicium has four states, e.g., 0, 1, 2, 3. The fraction of the indicia in each state in the picking pattern is proportional to the market demand for production devices meeting the performance specifications corresponding to the state.

In block 284, the first device behavioral model on the list corresponding to the state of the current indicium of the picking pattern is selected.

In the above-described embodiments, the performance metrics of each production device are predicted using the device behavioral model of the production device. The device behavioral model is generated by combining the component behavioral models of the production components constituting the production device. An exemplary method that may be used to generate the component behavioral models of the production components will be described next. The method is based on that described by Khoche et al. in U.S. patent application Ser. No. 11/098,080, assigned to the assignee of this disclosure and incorporated by reference.

Since the process of generating the component model form on which the component behavioral models of production components manufactured in accordance with a given component design are based typically requires detailed information on the structure of the component design and on the process used to manufacture the production components based on the component design, the behavioral models are typically generated by, or under the control of, the component manufacturer. Alternatively, as described above with reference to FIG. 2, the component manufacturer may supply the component model form to the device manufacturer. In this case, the component manufacturer additionally supplies to the device manufacturer a set of the values of the model form parameters for each production component supplied. As a further alternative, the component manufacturer provides the device manufacturer with information that would allow the device manufacturer or another entity to generate the component behavioral models of the production components. This typically involves the component manufacturer providing the device manufacturer with the component model form for each component design together with testing information that would allow the device manufacturer to test each production component received from the component manufacturer and to extract the values of the model form parameters for the production component from the test results.

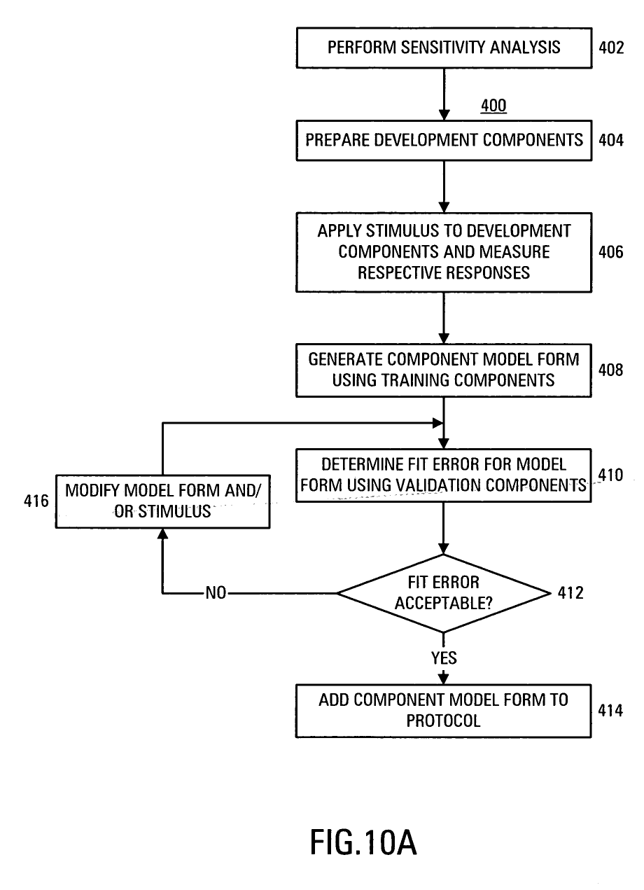

The above does not preclude the possibility of the device manufacturer performing the process described below with reference to FIGS. 9, 10A-10C and 11, or another process that generates component behavioral models, to generate respective component behavioral models for conventionally-tested production components received from a component manufacturer. Alternatively, the device manufacturer may have component behavioral models for conventionally-tested production components received from a component manufacturer generated by a third party. Component behavioral models generated by the device manufacturer, by the component manufacturer or by a third party will be regarded as being received by the device manufacturer when used as part of a device behavioral model.

The following exemplary process is performed for each component design whose performance metrics have a range of variation sufficient to produce a material effect on the performance metrics of production devices manufactured in accordance with the device design. Such component designs not only include the designs of the active components constituting the production design but also the designs of such passive components as the package of the device design in some cases.

FIG. 9 is a flow diagram that provides an overview of an exemplary method 300 that can be used to generate behavioral models of production components manufactured in accordance with a component design. Behavioral model generating method 300 has a development phase 310 and a production phase 320. In development phase 310, a protocol for use in production for generating component behavioral models of production components is developed. The production components are manufactured in accordance with a component design by a manufacturing process. In the production phase 320, processes defined by the protocol generated in the development phase 310 are applied each production component manufactured by the manufacturing process in accordance with the component design to generate a respective component behavioral model.

Development phase 310 comprises a block 312 and a block 314. In block 312, a component model form for the component design is developed. The component model form forms the basis of the component behavioral models of the production components manufactured in accordance with the component design. The component model form is based on the component design and the performance specifications and production process of the component design, and comprises a basis function and model form parameters. The basis function is a set of non-linear equations. Inserting appropriate values of the model form parameters into the basis function produces a component behavioral model that mathematically models the behavior of one or more development components in accordance with the component design. Simple component designs may be modeled using a component model form whose basis function is composed of a single non-linear equation. The development components used to develop the component model form in block 312 can be actual components manufactured in accordance with the component design or can be one or more simulated components in accordance with the component design.

In block 314, a stimulus for use in determining the values of the model form parameters of production components manufactured in accordance with the component design is specified.

As noted above, development phase 310 generates a protocol for use in production to generate respective component behavioral models of production components. The protocol comprises the component model form developed in block 312 and the stimulus specified in block 314.

Production phase 320 is composed of a block 322, a block 324 and a block 330. Production phase 320 is applied to each production component in accordance with the protocol developed in development phase 310.

In block 322, the stimulus specified in block 314 is applied to the production component and the response of the production component to the stimulus is measured.

In block 324, the component model form developed in block 312 is used to extract values of the model form parameters from a set of stimulus data representing the stimulus specified in block 314 of development phase 310 and a set of response data representing the measured response of the production component to the stimulus. The component model form and a fitting process are used to extract the values of model form parameters from the stimulus data and the response data. The values of the model form parameters extracted are those that, when inserted into the basis function to form a component behavioral model of the production component, give a close match between a calculated response of the component behavioral model of the production component to the stimulus and the measured response of the production component to the stimulus.

In block 330, the values of the model form parameters extracted in block 324 for the production component are inserted into the basis function of the component model form to generate the component behavioral model of the production component. Block 330 is omitted in embodiments in which the values of the model form parameters are supplied to the device manufacturer instead of the component behavioral models, as described above. In such embodiments, the values of the model form parameters supplied for insertion into the basis function of a component model form will be regarded as constituting a component behavioral model.

The behavioral model generated in block 330 may optionally be used instead of conventional parametric testing to determine compliance of the production component with the performance specifications of the component design, as disclosed by Khoche et al., cited above. FIG. 9 shows optional blocks 332 and 334 in which such determination is made. In block 332, performance metrics for the production component are predicted using the component behavioral model. Typically, the prediction involves calculating responses of the component behavioral model to one or more simulated stimuli. The calculated responses, or values derived from the calculated responses, then constitute the predicted performance metrics for the production component. In block 334, compliance of the performance metrics predicted in block 332 with respective ones of the performance specifications of the component design is determined. A production component whose predicted performance metrics all comply with their respective performance specifications is classified as good and is accepted.

Production components for which component behavioral models are generated using the component behavioral model generating method just described are typically analog or RF components. However, component behavioral models for production components having a mixture of analog elements and digital elements may be generated, and component behavioral models for predominantly digital components may be generated to the extent that the component design's behavior comprises analog behavior.

To develop a component behavioral model for a production component, a component model form comprising a basis function and model form parameters for the basis function is developed for the component design using one or more development components. The development components can be sample production components made in accordance with the component design or can be one or more simulated components based on the component design. Alternatively, both sample production components and simulated components can be used.

A set of non-linear equations is initially selected as the basis function of the component model form. To develop the component model form, an appropriate stimulus is applied to each development component and a respective response of the development component to the stimulus is measured. The stimulus and the respective responses of the development components are used to determine whether the component model form accurately models the behavior of the development components with respect to the performance specifications of the component design. The initially-selected equations are used to extract values of the model form parameters from data representing the stimulus and the response of the development components to the stimulus. The values of the model form parameters extracted are those that, when inserted into the initially-selected equations produce a component behavioral model that most closely fits the measured behavior of the development components with respect to the performance specifications of the component design. If the fit between the behavior of the component behavioral model based on the initially-selected equations and the behavior of the development components is unacceptable, the initially-selected equations are modified and the process just described is iterated until a component behavioral model based on the non-linear equations and appropriate values of the model form parameters accurately matches the measured or calculated behavior of the development components. Once the component behavioral model based on non-linear equations can accurately model the measured or calculated behavior of the development components with respect to the performance specifications of the component design, the non-linear equations can be used as the basis function of the component model form.

In many cases, a component behavioral model for each production component is generated by applying a single stimulus to the production component and performing a single set of measurements of the response of the production component to the stimulus. This enables the component behavioral models to be generated quickly using modest computational resources.

The behavioral model generating process described above with reference to the flow diagram shown in FIG. 9 will now be described in greater detail. Development of a component model form that represents the behavior of the component design occurs at block 312. The component model form developed in block 312 is a function of the component design, the acceptable ranges the parameters of the process used to manufacture the production components and the performance specifications of the component design. The capabilities of the test equipment used to provide the stimulus and measure the response of the production components to the stimulus may also be taken into account in developing the component model form. In an example, the component model form is developed in block 312 by taking input-output time domain samples of development components. The development components, also called training components, are selected to cover the acceptable range of process parameter variations. Using such development components enables a structure for the component model form to be developed that is responsive to the process parameter variations expected in production components based on the component design.

The component model form developed in block 312 comprises a non-linear basis function and model form parameters. The non-linear basis function can be a polynomial function, or can be a basis function such as a radial basis function (RBFs), a neural net, etc. The basis function and model form parameters are the same for all production components manufactured in accordance with a given component design, but the model form parameters differ in value among the production components. In some embodiments, the component model form is developed using the method of producing a behavioral model of a nonlinear component from embeddings of time-domain measurements described in U.S. Pat. No. 6,775,646, incorporated by reference. Other embodiments use other methods to develop the component model form.

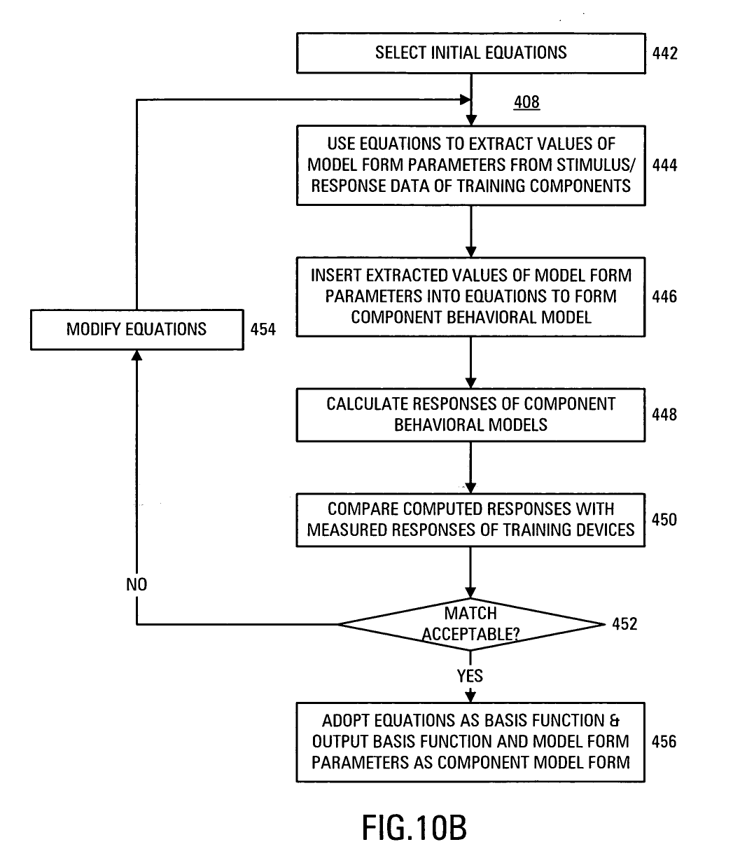

The component model form development process is typically performed only once for each component design. However, the quality of the component model form is typically periodically validated from time-to-time during production. A process that can be used for validation of the component model form will be described below with reference to FIG. 10C.

Physics-inspired component model forms are used in certain embodiments of the component model generating process. An example of a physics-inspired component model form is the following mathematical model for an amplifier:
vₒᵤₜ(t)=a₀+a₁vᵢₙ(t)+a₂vᵢₙ(t)²+a₃vᵢₙ(t)³+ . . . +aₙvᵢₙ(t)ⁿ
representing a Taylor expansion about vᵢₙ. The component model form is made up of model form parameters, a₀, a₁, . . . , aₙ, and a polynomial basis function. The component model form exemplified above is non-linear due to the higher-order terms in vᵢₙ (t).

Once the component model form is developed in block 312, a stimulus is specified in block 314. A stimulus is typically an electronic signal that is applied to each production component. The stimulus specified is one that, when applied to the production component, produces a response that can be measured to produce a measurement from which can be efficiently extracted the values of the model form parameters (e.g., values of a₀, a₁, . . . , aₙ) for the component model form generated in block 312. Specifying the stimulus in block 314 also involves specifying how the response of the production component to the stimulus is measured.

Typically, a stimulus and corresponding response measurement are specified such that, when the stimulus is applied to each production component in block 322, the measurement of the response of the production component to the stimulus will produce response data that, together with stimulus data representing the stimulus, allows the values of the model form parameters to be extracted efficiently in block 324, i.e., quickly, accurately and without using excessive computational resources. In many cases, the stimulus specified in block 314 is the stimulus or one of the stimuli used in block 312 to develop the component model form.

Stimulus specification in block 314 is typically performed in parallel with the model form development performed in block 312. Alternatively, the stimulus specification and the model form development may be interleaved in an iterative process.

Once a component model form has been developed in block 312 and a stimulus has been specified in block 314, the component model form and the stimulus can immediately become parts of a protocol for use in production phase 320 to generate the component behavioral models of production components. More typically, the protocol, comprising the component model form and the stimulus specification, is stored, for example, on a computer-readable medium, for use later and, typically, elsewhere, in production phase 320. In one example, the component model form is developed in block 312, the stimulus is specified in block 314 and the component model form and the stimulus specification are then saved for use later and, typically, elsewhere, in the production phase to generate component behavioral models of the production components manufactured in accordance with the component design.

The stimulus specification produced in block 314 typically describes the properties of the specified stimulus. The stimulus specification may alternatively be a set of waveform data that defines the waveform of the stimulus. In another possibility, the stimulus specification constitutes a set of instructions that cause a given piece or range of test equipment to generate a stimulus having the properties of the specified stimulus. The stimulus specification is typically stored in a machine-readable medium.

In the production phase 320, the processes described with reference to blocks 322, 324 and 326 are used to generate respective component behavioral models for the production components. The processes described with reference to blocks 322, 324 and 326 are each applied to each production component.

In block 322, the stimulus specified in block 314 is applied to the production component and the response of the production component to the stimulus is measured to generate response data representing the response of the production component to the stimulus. The measurement performed in block 322 is also specified in block 314.

In block 324, the component model form developed in block 312 is used to extract values of the model form parameters for the production component from the stimulus data representing the stimulus and the response data generated by the measurement performed in block 322 of the response of the production component to the specified stimulus. The component model form and a fitting process are used to extract the values of model form parameters from the stimulus data and the response data. In the above-mentioned example using the classical mathematical model for an amplifier:
vₒᵤₜ(t)=a₀+a₁vᵢₙ(t)+a₂vᵢₙ(t)²+a₃vᵢₙ(t)³+ . . . +aₙvᵢₙ(t)ⁿ
the values of model form parameters, a₀, a₁, . . . , aₙ are extracted from the stimulus data and the response data in block 324.

In block 330, the values of the model form parameters are inserted into the basis function to generate the component behavioral model provided to the manufacturer of the production devices. Alternatively, as noted above, the component model form may be provided to the manufacturer of the production devices together with values of the model form parameters for each production component.

The model form development process (block 312 of FIG. 9) begins with the initial selection of a set of non-linear mathematical equations as the basis function of the component model form. The initially-selected equations are equations that model the behavior of one or more development components in accordance with the component design with respect to the performance specifications of the component design. The equations can be selected with the assistance of a computer-aided design (CAD) program. For example, the equations can be selected with the assistance of a CAD program that uses a conventional, complex model of the component design.

The component model form is made simple by modelling the behavior of the component design with respect to the performance specifications of the component design, and ignoring behaviors of the component design that are not specified by the performance specifications. Model form parameters that have little or no relevance to the performance specifications can be ignored.

In one example, the initially-selected equations are specific to a nominal component in accordance with the component design. The initially-selected equations are then tested using additional development components and typically are modified to enable them to represent the behavior of the development components with respect to the performance specifications of the component design. The additional development components typically differ in behavior, at least in part, from the nominal development component.

A development component is a component in accordance with the component design. Preproduction samples made in accordance with the component design can be used as the development components. Special pre-production samples can be made in accordance with the component design with various combinations of process parameters at the extremes of their allowed ranges. Such samples constitute what is known as a skewed lot or a rainbow lot. Simulated components, simulated, for example, on a computer using simulation software may additionally or alternatively be used as development components. Examples of simulation software include CAD software, SPICE software and the above-mentioned Advanced Design System sold by Agilent Technologies, Inc, Palo Alto, Calif. Again, process parameters at the extremes of their allowed ranges may be used in the simulations.

Model form development using development components from skewed lots will next be described in more detail with reference to FIG. 10A.

FIG. 10A is a flow diagram showing an example of a model form development process in which a component model form for use in generating component behavioral models of production components manufactured in accordance with a component design is developed using development components from skewed lots. In block 402, a sensitivity analysis is performed using a component netlist, e.g., a SPICE deck, for the component design and using process parameters obtained from the process data kit of the fabrication process used to fabricate the production components. The sensitivity analysis determines a subset of the process parameters to which the performance of the component design is most sensitive. The component model form is developed to target the subset of the process parameters identified by the sensitivity analysis. In some embodiments, block 402 is omitted.

In block 404, development components are prepared for use in the model form development process. Typically, development components are prepared by performing manufacturing runs in which process parameters are intentionally skewed to cover the range of variations in the process parameters identified in block 402. This produces respective skewed lots of development components. The range of variations is defined in the process data kit for the target manufacturing process.

In block 406, a stimulus is applied to the development components prepared in block 404. The stimulus is characterized by a set of stimulus data that typically represents the waveform of the stimulus. The response of each development component to the stimulus is then measured and is represented a respective set of response data. Each set of response data typically represents the waveform of the response of the respective development component to the stimulus.

The development components are then divided into two groups; a training group for use in developing the component model form and a validation group for use in validating the component model form. The development components in the training group will be called training components; the development components in the validation group will be called validation components. The stimulus and response data for the training components are used in the process performed in block 408 to generate the component model form and those for the validation components are used in the process performed in block 410 to validate the component model form, as will be described below.

A component model form for the component design is generated in block 408. In block 408, initial equations are selected, the training components are modeled using the initial equations and values of the model form parameters extracted using the equations from stimulus/response data obtained from the training components, and a determination is made of whether the model form based on the equations models the measured behavior of the training components with acceptable accuracy. When the accuracy is unacceptable, the equations are modified and the accuracy determination is repeated. The equation modification and accuracy determination processes are repeated until the accuracy of the modeling is acceptable.

FIG. 10B is a flow diagram illustrating an example of the processing performed in block 408. In block 442, initial non-linear equations are selected that represent the behavior of a nominal component in accordance with the component design. The initial equations constitute an initial basis function for the component model form. Specifically, the selected initial non-linear equations represent aspects of the behavior of the nominal component specified in the performance specifications of the component design. The nominal component may be an actual component or a simulated component. Alternatively, non-linear equations that represent the behavior of other components such as production components or selected ones of the development components are initially selected.

The stimulus data and response data gathered in block 406 for the training components are then used to determine whether the initially-selected equations can accurately predict the measured responses of the training components to the stimulus. In block 444, the equations are used to extract values of the model form parameters from the stimulus data and the response data for each training component. The values of the model form parameters are extracted by applying a fitting process as described above performed using the initially-selected equations. In block 446, the extracted values of the model form parameters for each training component are then inserted into the equations to produce a component behavioral model of the training component. In block 448, the response of the component behavioral model of each training component to the stimulus data is calculated. In block 450, the calculated response of the component behavioral model of each training component is compared with the measured response of the training component. In block 452, a test is performed to determine whether the calculated responses of the component behavioral models of the training components accurately match the measured responses of the respective training components.

When the result in block 452 is NO, the initially-selected equations are modified in block 454, and the values of the model form parameters are then extracted using the modified equations in block 444, responses of the modified component behavioral models of the training components to the stimulus are calculated in block 446, the calculated responses of the modified component behavioral models are compared with the measured responses of the training components in block 450 and the acceptability of the match is re-tested in block 452. The process just described is iterated until the component model form based on the modified equations accurately represents one or more desired aspects of the response of the training components to the stimulus, i.e., until a YES result is obtained in block 452. When the result obtained in block 452 is YES, execution advances to block 456 where the equations in their current state of modification are adopted as the basis function of the component model form and the basis function and the model form parameters are output as the component model form for the component design.

Returning now to FIG. 10A, in block 410, the component model form generated in block 408 is validated using the validation components. The validation components are development components different from the training components used in block 408 to develop the component model form. The validation process gives a measure of the quality of the component model form developed in block 408 in terms of a fit error with respect to the validation components. The responses to the stimulus of the validation components were measured in block 406, described above.

FIG. 10C is a flow diagram illustrating an example of the validation process performed in block 410. In block 460, values of the model form parameters are extracted from the stimulus data and the response data for each validation component. The values of the model form parameters are extracted by applying a fitting process as described above using the component model form. In block 462, the extracted values of the model form parameters for each validation component are then inserted into the component model form to produce a component behavioral model of the validation component. In block 464, the response of the component behavioral model of each validation component to the stimulus data is calculated. In block 466, a fit error for the component model form is determined. The calculated response of each validation component is compared with the measured response of the validation component. Any difference between the response predicted using the model of the validation component and the measured response of the validation component constitutes a fit error of the component model form with respect to the validation component. The fit errors for all the validation components constitute a cumulative fit error for the component model form. The cumulative fit error provides a measure of the accuracy of the component model form.

Returning again to FIG. 10A, in block 412, a test is performed to determine whether the fit error generated in block 410 for the component model form generated in block 408 is acceptable. When the result obtained in block 412 is YES, execution advances to block 414, where the component model form is added to the protocol for use in generating respective component behavioral models for the production components manufactured in accordance with the component design.

When the test result obtained in block 412 is NO, execution advances to block 416, where either or both the component model form developed in block 408 and the stimulus used in block 406 is modified. Execution returns to block 410, and the model form validation process of blocks 410, 412, 414 and 416 is iterated until an acceptable fit error is obtained, i.e., until the test result obtained in block 412 is YES.

The validation process shown in blocks 410, 412, 414 and 416 may be omitted in some embodiments. The validation process just described may alternatively be performed using simulated development components as will described below.

Validation processes different from that described above with reference to FIG. 10C may be performed in block 410. In an example, each validation component is fully characterized using a set of conventional parametric tests to generate respective performance metrics. The above-described component behavioral models of the validation components are also characterized by calculating their responses to stimuli corresponding to those used in the conventional tests, and calculating respective performance metrics from the stimuli and the calculated responses. Differences between the calculated performance metrics and the corresponding measured performance metrics are determined. The differences for the validation components provide a measure of the accuracy of the component model form. The accuracy measure is then used instead of the fit error in block 412.

The model form development process described above with reference to FIG. 10A may be performed using simulated development components. In such an embodiment, in block 404, development component simulations are generated using a simulator, such as a CAD software program. The simulator generates the development component simulations using a complex model of the component design. The complex model typically has thousands of parameters. The component simulations are typically performed with process parameters intentionally skewed to cover the range of variations in the process parameters identified in block 402. The range of variations is defined in the process data kit for the target manufacturing process.

In block 406, a set of stimulus data is applied to each simulated development component and the response of the simulated development component to the set of stimulus data is calculated to generate a respective set of response data. The set of stimulus data typically represents the waveform of a stimulus. Each set of the response data typically represents the waveform of the calculated response of the simulated development component to the set of stimulus data.

The simulated development components are then divided into two groups as described above, i.e., training components for use in developing the component model form and validation components for use in validating the component model form. In block 408, the component model form for the component design is generated using the simulated training components and a model form generation process similar to that described above with reference to FIG. 10B. In block 410, the component model form generated in block 408 is validated using the simulated validation components and a process similar to that described above with reference to FIG. 10C. The validation process gives a measure of the quality of the component model form developed in block 408 in terms of a fit error with respect to the simulated validation components. The model form generation process and the model form validation process just described are iterated until an acceptable fit error is obtained, i.e., the test result obtained in block 412 is YES.

When the model form generation process of block 408 is performed using simulated development components, the model form validation process of block 410 may be performed using real development components as described above with reference to FIG. 10A

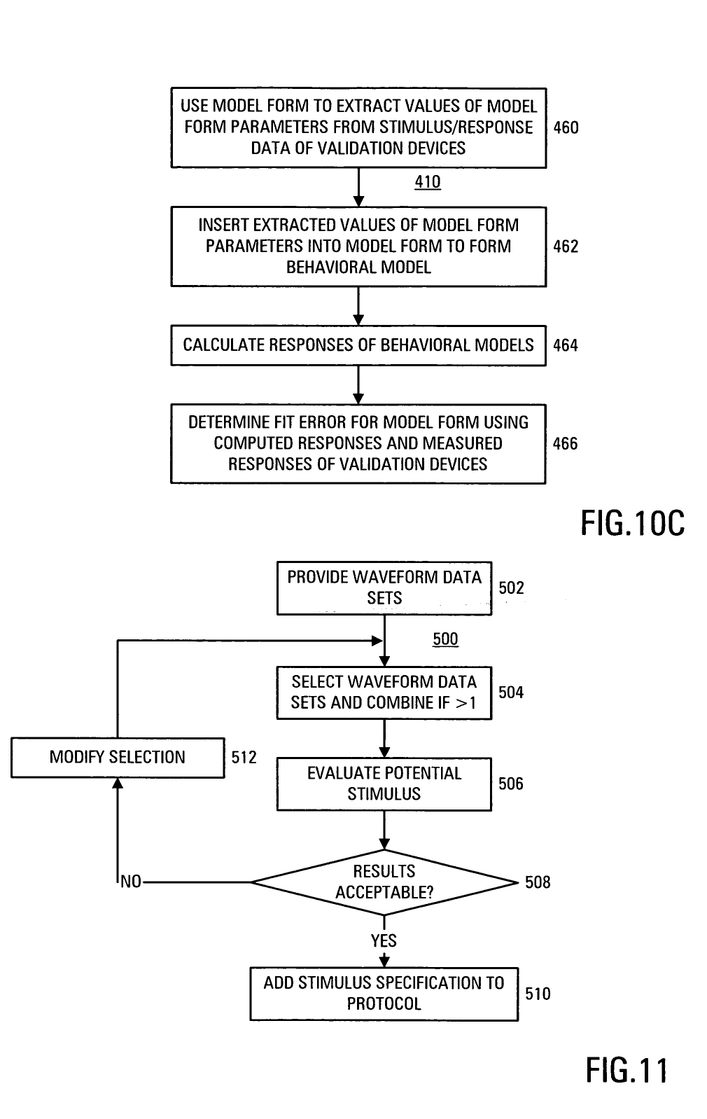

FIG. 11 is a flow diagram showing an example 500 of the processing performed in block 314 of FIG. 9 to specify the stimulus. In block 502 a library of sets of waveform data is provided. Each set of waveform data represents a respective waveform. For example, the waveforms represented by the waveform data are characterized by respective frequencies, amplitudes, phases and envelopes. Examples of the waveforms represented by the sets of waveform data include sine waves, noise, shaped noise, piecewise linear waveforms, step functions and pulses.

In block 504, at least one of the sets of waveform data is selected as a potential stimulus. When more than one set of waveform data is selected, the sets of waveform data are additionally merged to generate a set of waveform data representing a composite waveform. For example, sets of waveform data representing a carrier signal and a modulation signal may be merged to generate a set of waveform data representing a modulated carrier.

In block 506, the fitness of the potential stimulus generated in block 504 is evaluated. The set of waveform data is converted to a stimulus and the stimulus is applied to one or more development components. The response of each development component to the stimulus is measured to provide response data. Alternatively, the set of waveform data representing the potential stimulus is applied to a one or more simulated development components and the response of each simulated development component to the waveform data is calculated. The measured or calculated response data is then evaluated.

Selected sets of waveform data are deemed to be “fit” when the stimulus waveform generated in response to the waveform data is optimized for the extraction of the values of the model form parameters from the stimulus and the response of the production components to the stimulus. Such a stimulus waveform enables the values of the model form parameters to be extracted that enable the component behavioral model obtained by inserting the values of the model form parameters into the basis function of the component model form to-predict accurately the properties of each production component with the simplest and fastest possible measurement process. As noted above, the stimulus can be specified to provide a specified balance between speed, accuracy and complexity. One aspect of the accuracy of the prediction provided by the behavioral model is characterized in terms of the responsiveness of the prediction to the process parameter variations identified in process 402 of FIG. 10A.

In block 508, a test is performed to determine whether the results of the evaluation performed in block 506 are acceptable. When the test result obtained in block 508 is YES, execution advances to block 510, where the stimulus specification defining the stimulus evaluated in block 506 is added to the protocol produced by development phase 310. When the test result obtained in block 508 is NO, execution advances to block 512, where the selection of the sets of waveform data is modified in block 512, and blocks 504, 508 and 512 are repeated until the test result obtained in block 508 is YES.

This disclosure describes the invention in detail using illustrative embodiments. However, the invention defined by the appended claims is not limited to the precise embodiments described.

We claim:

1. A method of making a multi-component production device in accordance with a device design having performance specifications, the method comprising:
receiving respective component behavioral models of the production components constituting the production device;
combining the component behavioral models in accordance with the device design to form a device behavioral model; and
prior to assembling the production device, predicting performance metrics for the production device by performing simulated tests on the device behavioral model.

2. The method of claim 1, additionally comprising checking compliance of the predicted performance metrics of the production device with the performance specification of the device design.

3. The method of claim 2, additionally comprising, when the checking indicates that the performance metrics comply with the performance specifications, assembling the production components to form the production device.

4. The method of claim 1, additionally comprising, when the checking indicates that the performance metrics do not comply with the performance specifications:
in the device behavioral model, replacing one of the component behavioral models with the component behavioral model of a substitute component of the same type to create a modified device behavioral model; and
repeating the predicting and the checking using the modified behavioral model.

5. The method of claim 4, additionally comprising, when the repeated checking indicates that the performance metrics comply with the performance specifications, assembling the production components corresponding to the component behavioral models constituting the modified device behavioral model.

6. The method of claim 1, in which:
the receiving comprises receiving batches of component behavioral models corresponding to batches of the production components;
the method additionally comprises making sets of the component behavioral models from the batches of component behavioral models;
the combining comprises combining the component behavioral models in each set of the component behavioral models to form the device behavioral model of a respective possible production device;
the predicting comprises predicting performance metrics for each possible production device by performing simulated tests on the device behavioral model thereof; and
the method additionally comprises selecting for assembly the production components whose component behavioral models constitute the respective device behavioral models of those of the possible production devices that meet a specified manufacturing objective.

7. The method of claim 6, in which the manufacturing objective comprises maximizing the number of production devices whose performance metrics comply with the performance specifications.

8. The method of claim 7, in which the selecting comprises:
generating a list in which those of the device behavioral models whose predicted performance metrics meet the performance specifications are ranked in order of the number of other device behavioral models in which one the component behavioral models thereof is used;
selecting for assembly the production components whose respective component behavioral models constitute the one of the device behavioral models for which the number of other device behavioral models is least; and
removing from the list all the device behavioral models that comprise the component behavioral models of the production components selected for assembly.

9. The method of claim 6, in which the manufacturing objective comprises maximizing the performance metrics of the production devices.

10. The method of claim 9, in which the selecting comprises:
deriving a performance-indicting metric from the predicted performance metrics of each of the possible production devices;
generating a list in which ones of the device behavioral models whose predicted performance metrics meet the performance specifications are ranked in order of their performance-indicating metrics;
selecting for assembly the production components whose respective component behavioral models constitute the one of the device behavioral models having the highest performance-indicating metric; and
removing from the list all of the device behavioral models that comprise the component behavioral models of the production components selected for assembly.

11. The method of claim 6, in which:
the device design has more than one set of performance specifications; and
the manufacturing objective comprises maximizing the number of production devices that comply with one of the sets of performance specifications.

12. The method of claim 6, in which:
the device design has more than one set of performance specifications; and
the manufacturing objective is approximating the number of production devices that comply with each set of performance specifications to market demand for the production devices that comply with the respective set of performance specifications.

13. The method of claim 12, in which:
the method comprises generating a picking pattern having a density of states proportional to the market demand for the production devices that comply with the respective sets of performance specifications;
deriving a performance-indicting metric from the predicted performance metrics of each of the possible production devices;
generating a list in which those of the device behavioral models whose predicted performance metrics comply with any of the sets of performance specifications are ranked in order of their performance-indicating metrics;
selecting for assembly the production components whose respective component behavioral models constitute the one of the device behavioral models having one of (a) the highest performance-indicating metric and (b) the lowest performance-indicating metric, depending on the state of the picking pattern; and
removing from the list all of the device behavioral models that comprise the component behavioral models of the production components selected for assembly.

14. The method of claim 12, in which:
the method comprises generating a picking pattern having a density of states proportional to the market demand for the production devices that comply with the respective sets of performance specifications;
deriving a performance-indicting metric from the predicted performance metrics of each of the possible production devices;
generating a first list in which those of the device behavioral models whose predicted performance metrics comply with a first one of the sets of performance specifications are ranked in order of their performance-indicating metrics;
generating a second list in which ones of the device behavioral models whose predicted performance metrics comply with a second one of the sets of performance specifications are ranked in order of their performance-indicating metrics;
selecting for assembly the production components whose respective component behavioral models constitute the one of the device behavioral models having the highest performance-indicating metric on one of the first list and the second list depending on the state of the picking pattern; and
removing from the first list and from the second list all of the device behavioral models that comprise the component behavioral models of the production components selected for assembly.

15. The method of claim 6, in which the making comprises making one of the sets of component behavioral models from each allowed combination of the component behavioral models.

16. The method of claim 6, in which:
each of the component behavioral models is based on a component model form for a respective component design, the component model form comprising a basis function and model form parameters;
the receiving comprises:
receiving the component model forms, and
receiving respective values of the model form parameters for the production components; and
the combining comprises:
combining the component model forms in accordance with the device design to form a device model form; and
inserting the values of the model form parameters into the component model forms constituting the device model form to form the device behavioral model.

17. The method of claim 1, in which:
each of the component behavioral models is based on a component model form for a respective component design, the component model form comprising a basis function and model form parameters;
the receiving comprises:
receiving the component model forms, and
receiving values of the model form parameters for the production components; and
the combining comprises:
combining the component model forms in accordance with the device design to form a device model form; and
inserting the values of the model form parameters into the component model forms constituting the device model form to form the device behavioral model.

18. The method of claim 1, in which the receiving comprises:
generating a component model form for a respective component design of one of the production components, the component model form comprising a basis function and model form parameters;
using the component model form, extracting values of the model form parameters from a measurement performed on the one of the components; and
generating the component behavioral model of the one of the components using the basis function and the extracted values of the model form parameters.

19. A method of making a production device in accordance with a device design having performance specifications, the production device comprising production components each in accordance with a respective component design, the method comprising:
receiving a component model form for each of the component designs, the component model form comprising a basis function and model form parameters;
combining the component model forms in accordance with the device design to form a device model form;
receiving values of the model form parameters for the production components;
inserting the values of the model form parameters into the component model forms constituting the device model form to form a device behavioral model of the production device; and
prior to assembling the production device, predicting performance metrics for the production device by performing simulated tests on the device behavioral model.

20. The method of claim 19, additionally comprising checking compliance of predicted performance metrics of the production device with the performance specifications of the device design.

21. The method of claim 20, additionally comprising, when the checking indicates that the predicted performance metrics comply with the performance specifications, assembling the production components to form the production device.

22. The method of claim 19, in which:
the receiving the values of model form parameters comprises receiving batches of model form parameters corresponding to batches of the production components;
the method additionally comprises making sets of the model form parameters from the batches of model form parameters;
the inserting comprises inserting the model form parameters in each set of the model form parameters into the component model forms constituting the device model form to form the device behavioral model of a respective possible production device;
the predicting comprises predicting performance metrics for each possible production device by performing simulated tests on the device behavioral model thereof; and
the method additionally comprises selecting for assembly the production components whose component behavioral models constitute the respective device behavioral models of the possible production devices that meet a specified manufacturing objective.
